(19) United States
(12) Patent Application Publication
(10) Pub. No.: US 2025/0392194 A1
(43) Pub. Date: Dec. 25, 2025

(54) ADAPTOR FOR ROTATING ELECTRICAL MACHINE

(71) Applicant: Cummins Generator Technologies Limited, Peterborough (GB)

(72) Inventors: Jianguang Tang, Peterborough (GB); Teddy Wu, Peterborough (GB); Roy Hua, Peterborough (GB); Peter Yang, Peterborough (GB); Zhou Zhou, Peterborough (GB); Mark Jason Riley, Peterborough (GB)

(73) Assignee: Cummins Generator Technologies Limited, Peterborough (GB)

(21) Appl. No.: 18/880,459

(22) PCT Filed: Jun. 1, 2023
(86) PCT No.: PCT/GB2023/051446

§ 371 Date: Dec. 31, 2024

(30) Foreign Application Priority Data
Jul. 1, 2022 (GB) 2209713.3

(51) Int. Cl. H02K 7/18; F01P 5/06; F02B 63/04; H02K 9/06

(52) U.S. Cl. CPC H02K 7/1815; H02K 9/06; F01P 5/06; F02B 63/042

(57) ABSTRACT

An adaptor for connecting a rotating electrical machine to a prime mover is disclosed. The adaptor comprises a first part (52) arranged to surround a fan, and a second part (54) arranged to provide access to a rotating component for connecting the rotating electrical machine to the prime mover. The first part provides the appropriate air diffusion properties for the fan, and the second part provides suitable openings to access the rotating component. This may help to improve airflow rate from the fan while at the same time providing access to the rotating component.

The present invention relates to an adaptor for connecting a rotating electrical machine to a prime mover, and in particular an adaptor which can help improve airflow through the machine and facilitate connection of the machine to the prime mover.

Power generation systems typically comprise a prime mover connected to a rotating electrical machine. For example, a generating set may comprise an internal combustion engine, such as a diesel engine, coupled to a generator (alternator). The engine is used to drive the generator, in order to generate the output power. This is achieved by mechanically connecting rotating parts of the engine and the generator. The engine and the generator are typically both mounted on a bed frame. An adaptor may be used to connect non-rotating parts of the generator and the engine, such as the generator frame and a flywheel housing. The adaptor may convert one set of connections on the generator to another set of connections on the prime mover. Use of an adaptor helps to prevent relative movement between the engine and the generator.

Many rotating electrical machines, particularly those of a larger design, require some form of cooling. This may be achieved by providing a fan which forces air flow through the machine. The fan may be mounted on the machine shaft inside the adaptor. Air outlets are provided in the adaptor in order to provide exit paths for the airflow. The air outlets may also provide access for an operator to connect rotating parts of the engine and the generator during assembly.

International patent application number WO 2017/158322 A1, the subject matter of which is incorporated herein by reference, discloses an adaptor with a plurality of air outlets, and walls which are arranged to provide an increase in a cross-sectional area of airflow towards the air outlets. The walls may provide a progressive reduction in air velocity through steady expansion of the airflow cross-section, which may help to increase the airflow rate through the machine.

International patent application number WO 2019/243829 A1, the subject matter of which is incorporated herein by reference, discloses an adaptor with a rear member, a front member, and a plurality of wedge-shaped cross members. The cross members may act as diffusers for airflow from the fan, helping to achieve good airflow and thermal performance while also being efficient from a structural and cost perspective.

The adaptors disclosed in WO 2017/158322 A1 and WO 2019/243829 A1 can help to improve airflow through the machine. However, in existing adaptor designs, it is also necessary for the adaptor to provide access to the drive coupling in order to connect the machine to the prime mover. It has been found that in practice this may sacrifice some of the air diffusing capability of the adaptor. This in turn may lead to a reduction in heat dissipation.

It would therefore be desirable to increase the airflow rate through the machine by improving the air diffusing properties of the adaptor, while at the same time allowing access to rotating components.

According to one aspect of the present invention there is provided an adaptor for connecting a rotating electrical machine to a prime mover, the adaptor comprising:
a first part arranged to surround a fan; and
a second part arranged to provide access to a rotating component for connecting the rotating electrical machine to the prime mover.

The present invention may provide the advantage that, by separating the adaptor into a first part arranged to surround a fan and a second part arranged to provide access to a rotating component for connecting the machine to the prime mover, it may be possible for the first part to provide appropriate air diffusion properties for the fan and for the second part to provide suitable openings to access the rotating component. This may help to improve airflow rate from the fan while at the same time providing access to the rotating component.

Preferably the first part is arranged to connect to the rotating electrical machine, and the second part is arranged to connect to the prime mover. For example, the first part may be arranged to connect to a housing or frame of the machine, and the second part may be arranged to connect to a non-rotating part of the prime mover such as a flywheel housing.

The fan may be, for example, a fan mounted on a shaft of the rotating electrical machine. The fan is preferably arranged to draw cooling air through the machine. The rotating component may be, for example, a coupling disc, and may be arranged to connect to a rotating component of the prime mover, such as a flywheel or other rotating component such as a shaft. The rotating component may be connectable to the prime mover, for example, using bolts, or using any other appropriate fastener.

Preferably the first part and the second part are adjacent to each other in an axial direction, and preferably adjoining each other. Thus, the first part and the second part in combination may be used to make a physical connection between the machine and the prime mover, for example, between a machine housing and a flywheel housing.

The second part is preferably arranged to space the first part axially from the prime mover. This may allow the second part to provide space for accessing the interior of the adaptor when connecting the rotating electrical machine to the prime mover, while allowing the first part to provide appropriate air diffusion properties for the fan.

The second part may comprise a front member and a plurality of cross members which connect the front member to the first part. The front member may be, for example, in the form of an annular disc. The front member may be arranged to connect to a non-rotating part of the prime mover, such as a flywheel housing. The cross members may extend axially between the front member and the first part. This may allow the second part to space the first part axially from the prime mover. The cross members may have, for example, a T-shaped or U-shaped cross section, or any other appropriate shape.

Preferably an access window is defined between two adjacent cross members in a circumferential direction. The access window may allow access to a rotating component such as a coupling disc for connecting the machine to the prime mover. Preferably, the access window is arranged to allow the insertion and rotation of a tool for connecting the rotating electrical machine to the prime mover. For example, the access window may allow the insertion and rotation of a wrench to tighten bolts which connect a coupling disc to an engine flywheel and/or bolts which connect the adaptor to a flywheel housing. The access window may be larger in a circumferential direction than in an axial direction, in order to allow the tool to be rotated while minimising the axial width of the second part.

The first part is preferably arranged to allow cooling air to exit the machine. Thus, the first part may comprise a plurality of exit paths for airflow from the fan.

The first part may for example act as a diffuser, that is, it may function to ensure the movement of air from a region of higher concentration to a region of lower concentration. For example, the first part may be arranged to provide a steady expansion of the airflow cross-section in the direction of airflow through the adaptor. This may provide a progressive reduction in air velocity, which may help to convert part of the dynamic pressure into additional static pressure. This in turn may help to improve the overall amount of cooling air passing through the machine for a given fan input power.

The adaptor may comprise a middle member which may be for example in the form of an annular disc. The middle member may act as a wall to at least partially separate the first part and the second part of the adaptor. For example, the middle member may help to guide airflow from the fan in a radially outwards direction and/or at least partially prevent airflow from the fan from entering the second part. The middle member may be provided as part of the first part and/or as part of the second part of the adaptor, or as a separate component.

The first part may comprise a rear member and a plurality of vanes which extend axially outwards from the rear member. For example, the first part may comprise a rear member, a middle member, and a plurality of vanes which connect the middle member to the rear member. Alternatively, the middle member may be provided on the second part. The middle member and/or the rear member may be ring-shaped. For example, the middle member and/or the rear member may be in the form of annular discs. The vanes may function to physically connect the middle member to the rear member. Thus, the vanes may function to ensure the physical rigidity of the adaptor while also providing air diffusion properties. The vanes may be, for example, flat, wedge-shaped, aerofoil-shaped, or any other appropriate shape. Exit paths may be defined between adjacent vanes, to allow airflow to exit the machine.

The vanes may be at a (non-zero) angle with respect to a radial direction through the adaptor. Thus, a centre line through a vane (e.g. a line which is at an equal distance to two side surfaces of the vane and/or which runs from a radially inward edge of the vane through the centre of the vane) may be angled with respect to the radial direction when viewed axially. For example, the vanes may be at an angle which is approximately equal to an angle at which airflow exits the fan. This may help to ensure that the vanes cause minimal blockage to the airflow.

Where the second part comprises a front member and a plurality of cross members, the number of vanes may be greater than the number of cross members. This may allow the second part to provide access windows which are sufficiently large in a circumferential direction to allow connection of the machine to the prime mover, while allowing the number of vanes to be optimised for airflow.

Preferably the second part has a width in an axial direction which is less than the width of the first part. This may allow a reduced number of cross members to be used in the second part, thereby allowing access windows of the desired size to be provided. In particular, it may be possible to provide access windows which are relatively large in a circumferential direction, which may allow rotation of a wrench when tightening a bolt.

The vanes preferably have a width in an axial direction which is substantially the same as the width of the fan. This may help to improve the ability of the fan to draw cooling air, by avoiding or reducing axial gaps or voids adjacent to the fan blades.

The fan may further comprise a backplate, in which case the middle member may be substantially aligned with the backplate in an axial direction. For example, the middle member may be located radially outwards of the back plate. This may help to ensure smooth airflow through the fan, and thus may help with cooling.

In one embodiment, the first part and the second part are formed integrally. For example, the first part and the second part may be moulded as a single component, or manufactured in any other way (for example, fabrication).

In another embodiment, the first part and the second part are manufactured as separate components. In this case, the second part may be removably connected to the first part. This may allow different types of second part to be used with the same type of first part. Thus, the adaptor may be arranged such that a plurality of different types of second part can be connected to the first part. For example, the second part may be replaceable to match with different flywheel housing connections, instead of replacing the whole adaptor. Furthermore, the second part may be replaced with a bearing support part. This may allow single and double bearing machines to share the same first part.

In some embodiments the axial width of the second part may be relatively small. This may allow a larger window to be provided in a circumferential direction, which may help with assembly. However, in some circumstances, it is possible that the relatively small axial width of the second part may restrict hand access. Thus, in some embodiments, a section of the adaptor is removable to provide improved access.

The adaptor may therefore comprise at least one section which is removable to improve access to the rotating component for connecting the rotating electrical machine to the prime mover. The removable section may comprise, for example, at least a part of a front member, a middle member or a vane, or any other part, or any combination thereof.

In a further embodiment, the adaptor further comprises at least one removable cover, and at least one removable cover comprises a vane. The vane may be provided at a location on the cover which corresponds to an area of the first part which does not have a vane. The vane on the cover may have a shape which is the same as or similar to at least one of the vanes on the first part. Thus, for example, the first part may have a “missing” vane in order to improve access, and the aerodynamic properties of the “missing” vane may be re-introduced as part of the removable cover. This may allow the adaptor to have an aerodynamic performance which is similar to one in which the vane is not missing.

As mentioned above, the first part may be arranged to connect to a housing of the machine. Thus, the first part may comprise the appropriate connections (such as bolt holes) for connecting the adaptor to the machine housing. Alternatively, the machine housing and the first part may be provided as a single component. The single component may be for example a fabricated component. Thus, the first part may be integral with a machine housing.

According to another aspect of the invention there is provided a rotating electrical machine comprising an adaptor in any of the forms described above. The rotating electrical machine may comprise a rotor, a stator, a housing, a shaft, a fan mounted on the shaft, and/or a coupling disc for connecting the machine to the prime mover.

According to another aspect of the invention there is provided a generator set comprising an engine, a generator, and an adaptor in any of the forms described above.

Corresponding methods may also be provided. Thus, according to a further aspect of the invention there is provided a method of connecting a rotating electrical machine to a prime mover using an adaptor, the adaptor comprising a first part and a second part, the method comprising:
connecting the adaptor to the rotating electrical machine such that the first part surrounds a fan; and
accessing a rotating component through the second part to connect the rotating electrical machine to the prime mover.

Features of one aspect of the invention may be provided with any other aspect. Apparatus features may be provided with method aspects and vice versa.

As used herein, terms such as “axially”, “radially” and “circumferentially” are generally defined with reference to the axis of rotation of the electrical machine, unless the context dictates otherwise.

Preferred features of the present invention will now be described, purely by way of example, with reference to the accompanying drawings, in which:

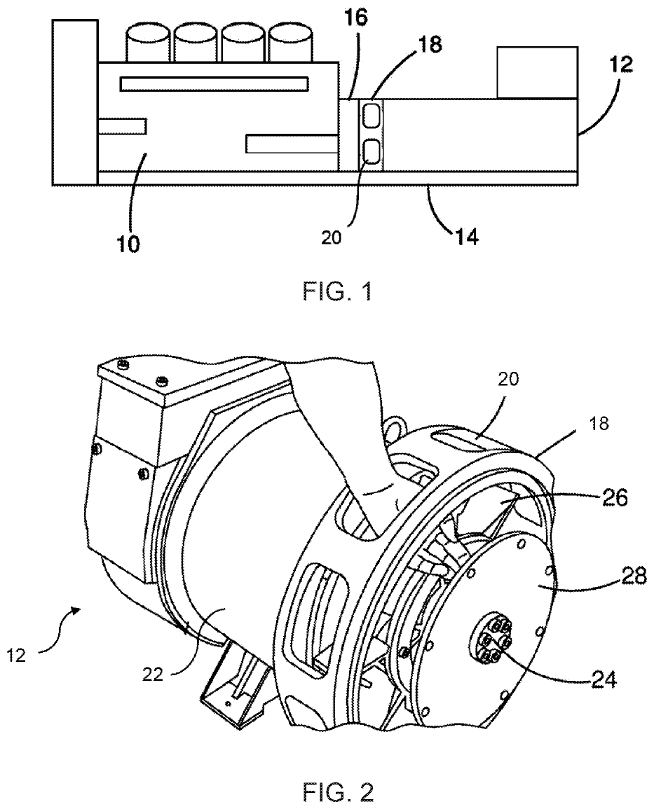

FIG. 1 shows schematically a generating set;

FIG. 2 shows parts of a generator prior to assembly to an engine;

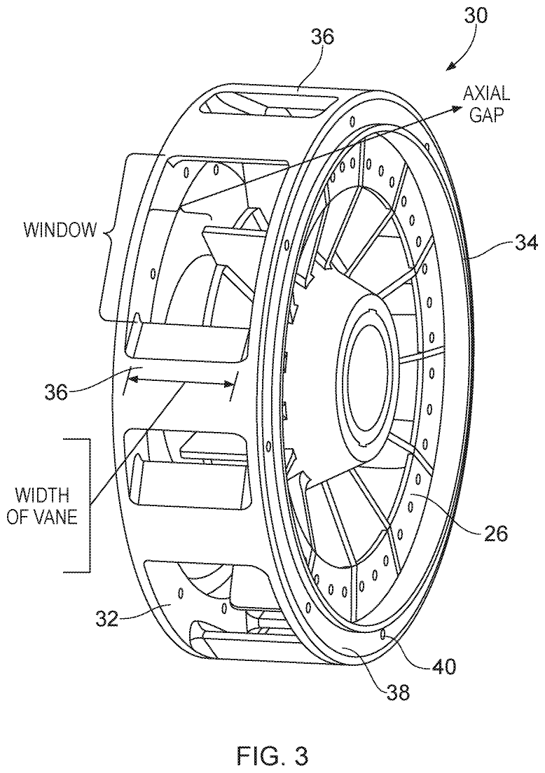

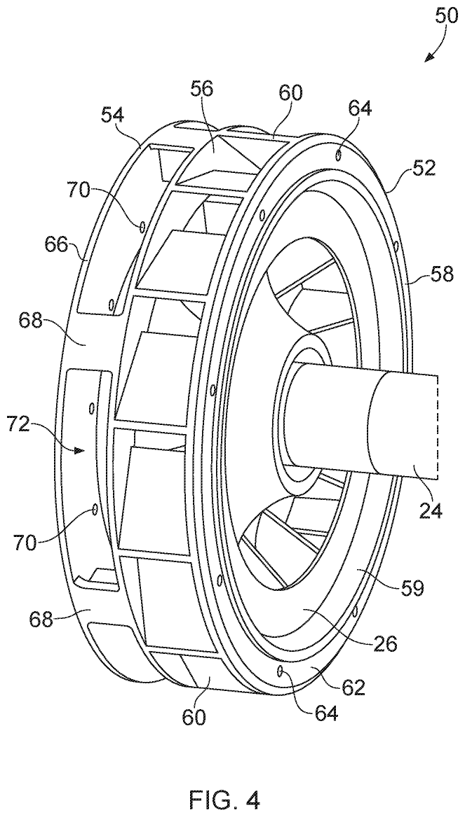

FIG. 3 shows a previously considered adaptor design;

FIG. 4 shows an adaptor in an embodiment of the invention;

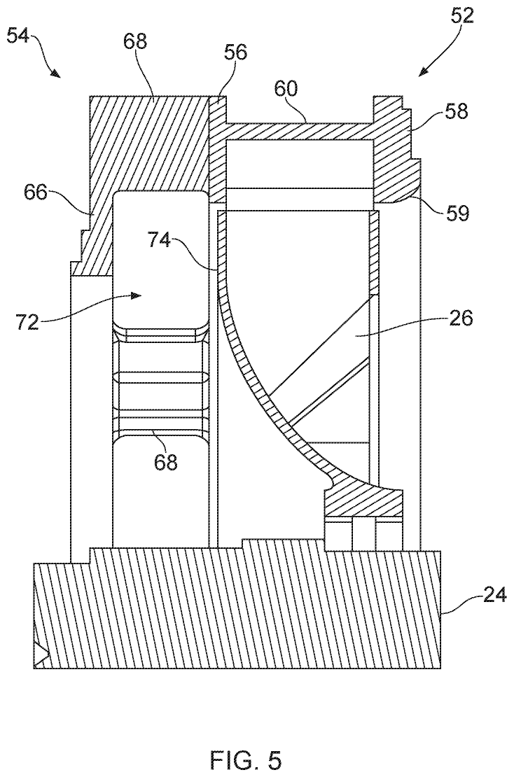

FIG. 5 shows a cut-away view of part of the adaptor of FIG. 4;

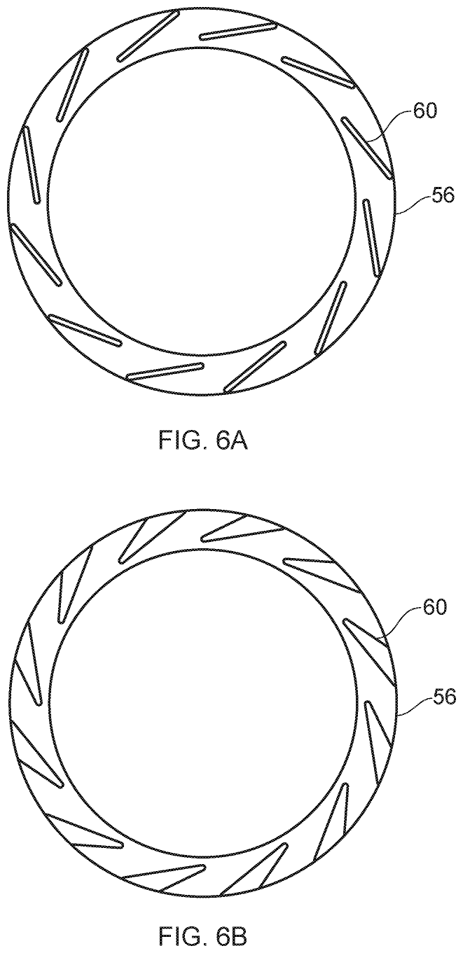

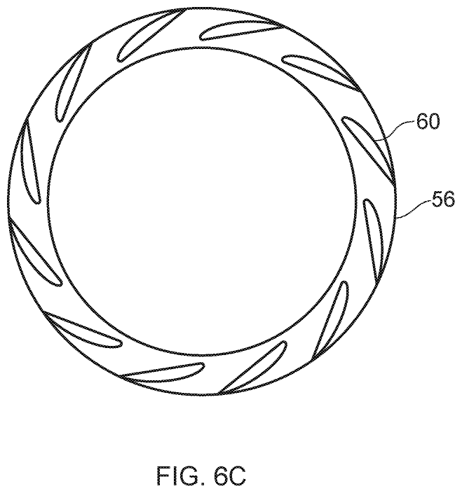

FIGS. 6A to 6C show axial cross sections through a diffuser part of an adaptor;

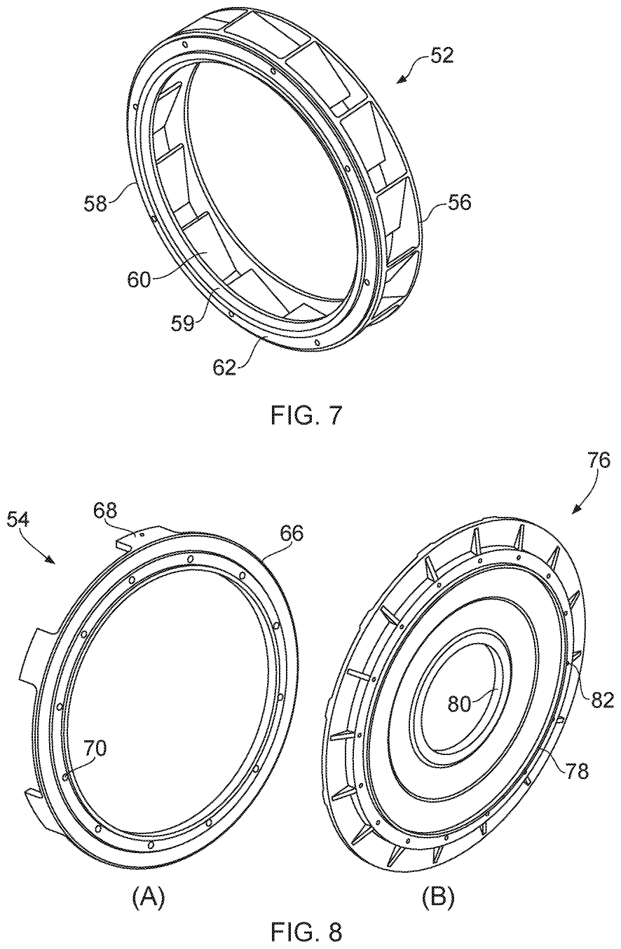

FIG. 7 shows a diffuser part of an adaptor in one embodiment;

FIG. 8A shows a spacer part for connection to the diffuser part of FIG. 7;

FIG. 8B shows a bearing support part for connection to the diffuser part of FIG. 7;

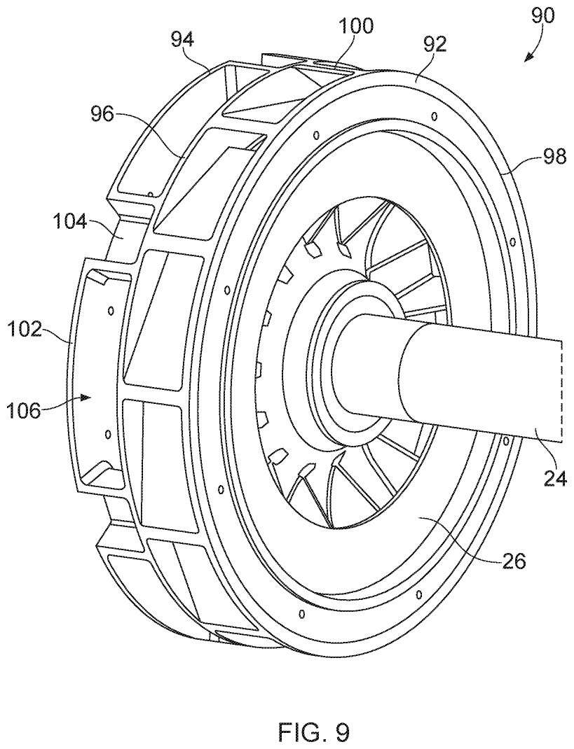

FIG. 9 shows an adaptor in another embodiment of the invention;

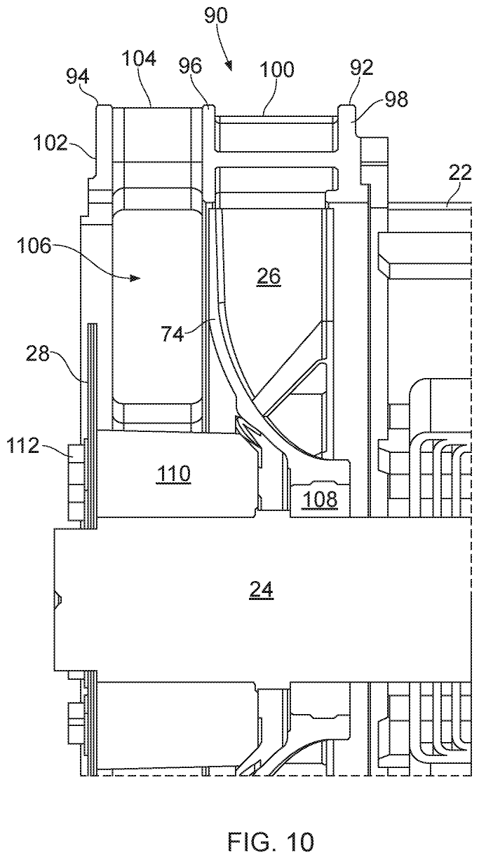

FIG. 10 shows a cutaway view through part of a generator with the adaptor of FIG. 9;

FIGS. 11A and 11B show an adaptor in another embodiment of the invention;

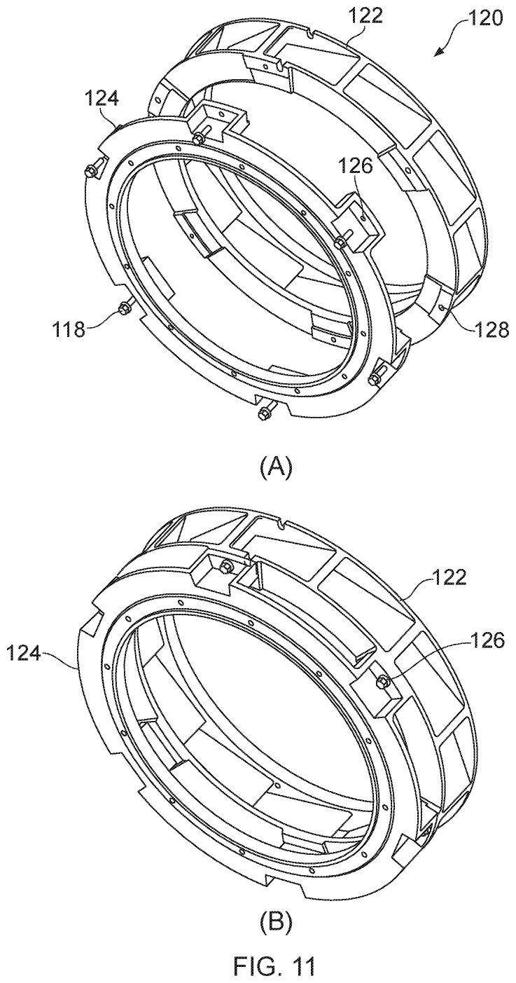

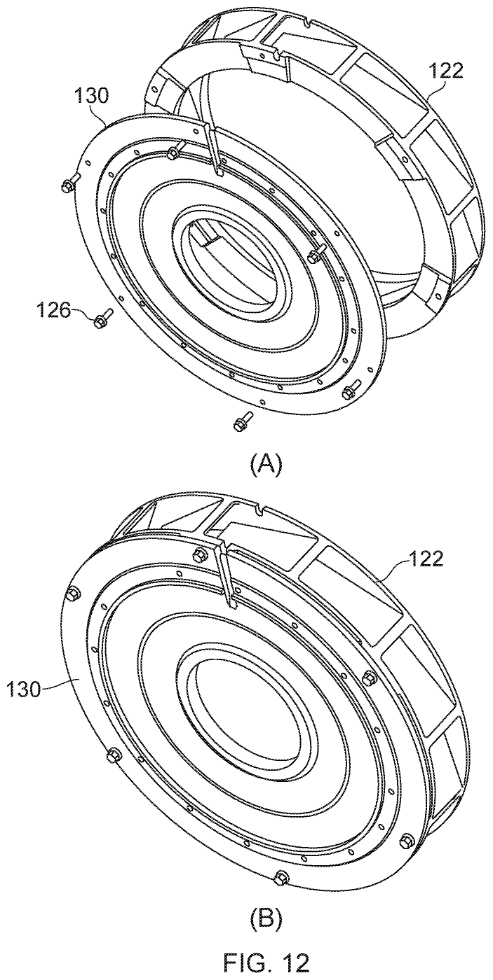

FIGS. 12A and 12B illustrate how the diffuser part of FIGS. 11A and 11B can be used together with a bearing support part;

FIG. 13 shows an adaptor in another embodiment of the invention;

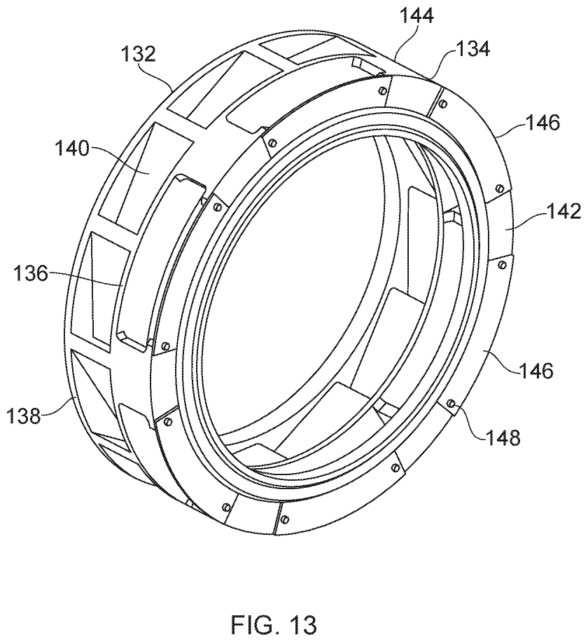

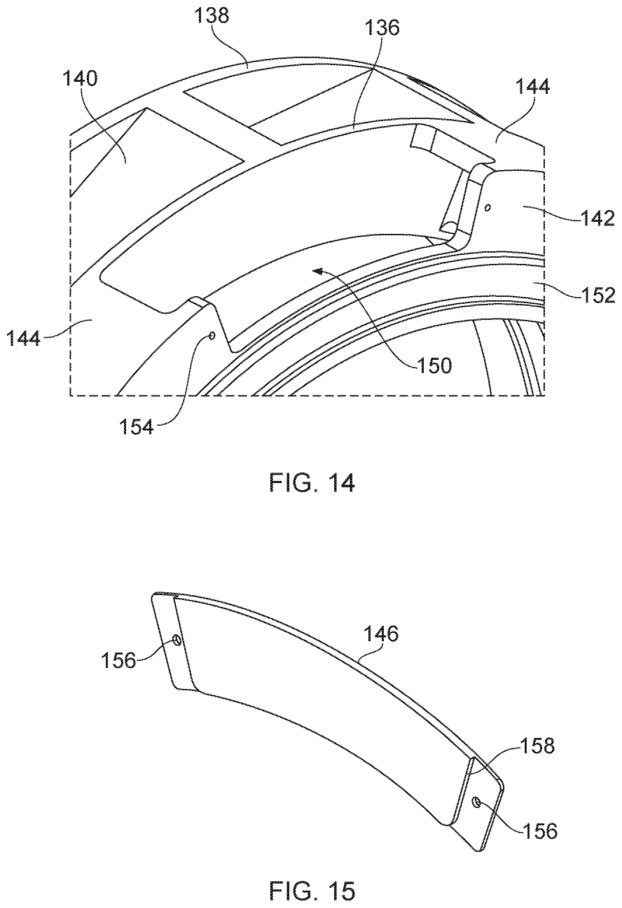

FIG. 14 shows part of the adaptor of FIG. 13 with a removable section removed;

FIG. 15 shows a removable section in more detail;

FIG. 16 shows an adaptor in another embodiment of the invention;

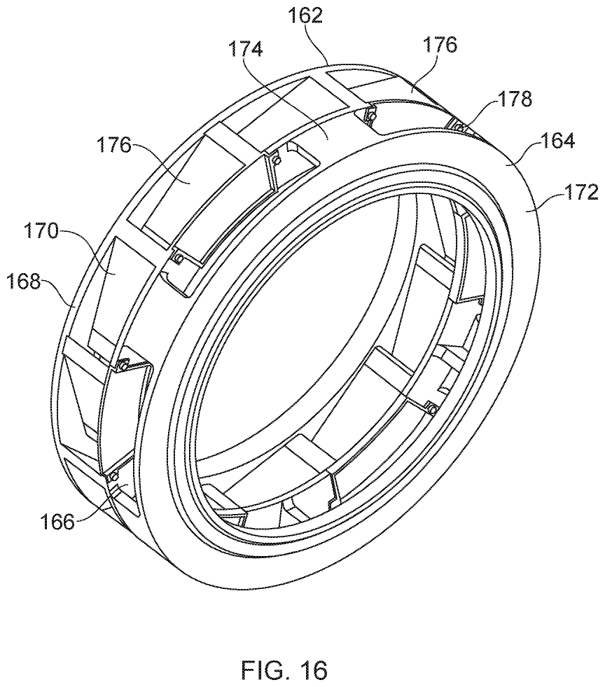

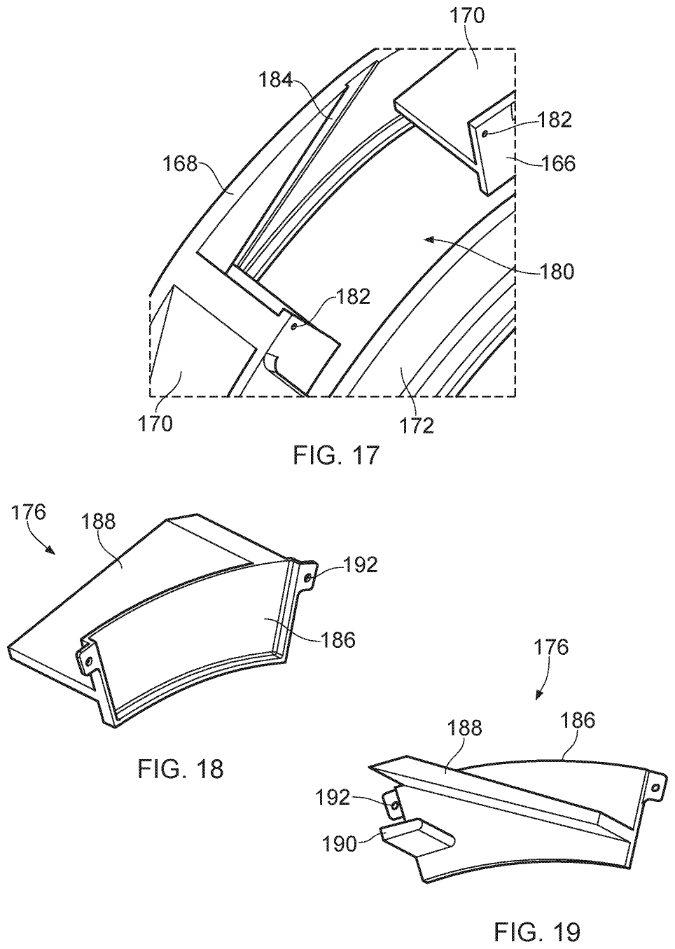

FIG. 17 shows part of the adaptor of FIG. 16 with a removable vane section removed;

FIGS. 18 and 19 show a front view and rear view of a removable vane section;

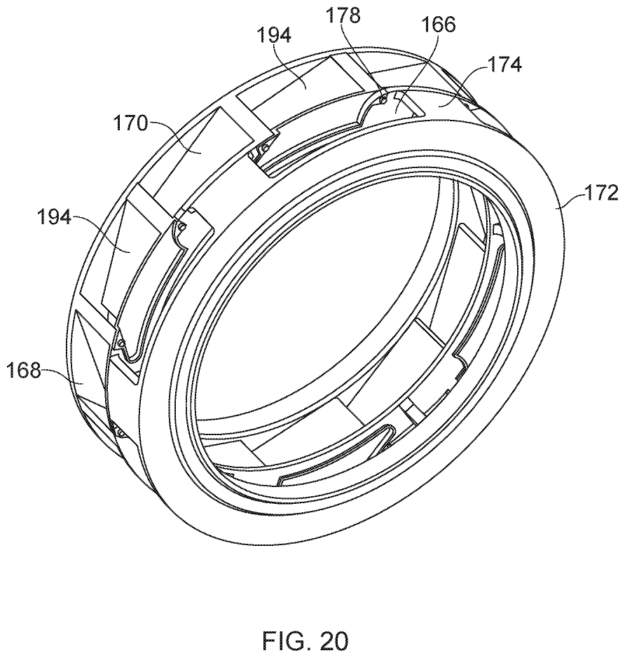

FIG. 20 shows an adaptor in another embodiment of the invention;

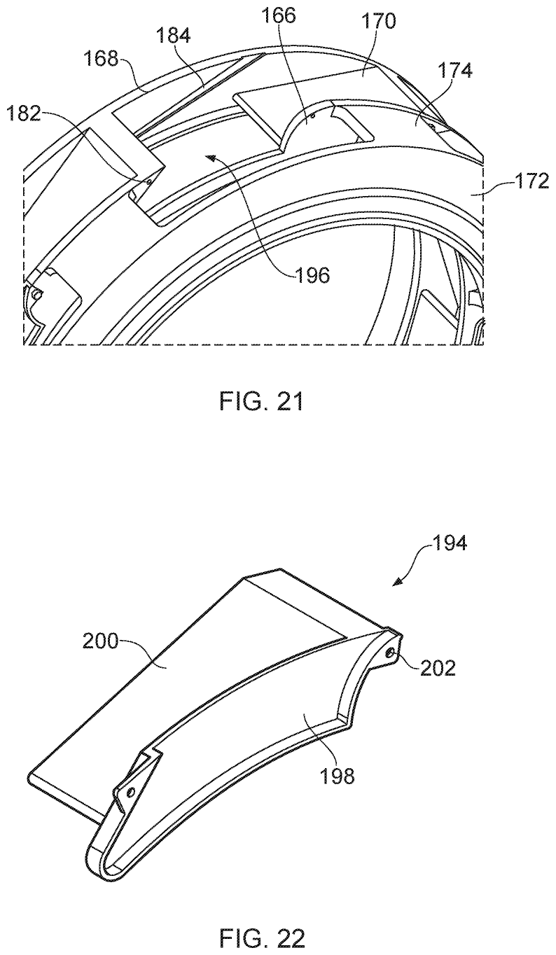

FIG. 21 shows part of the adaptor of FIG. 20 with a removable vane section removed;

FIG. 22 shows a removable vane section in more detail;

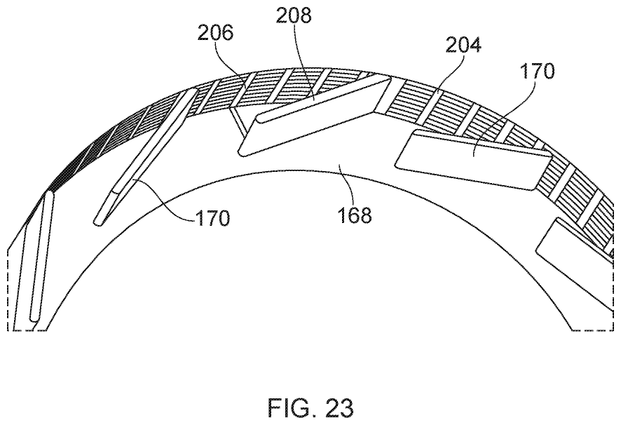

FIG. 23 shows part of an adaptor in another embodiment of the invention;

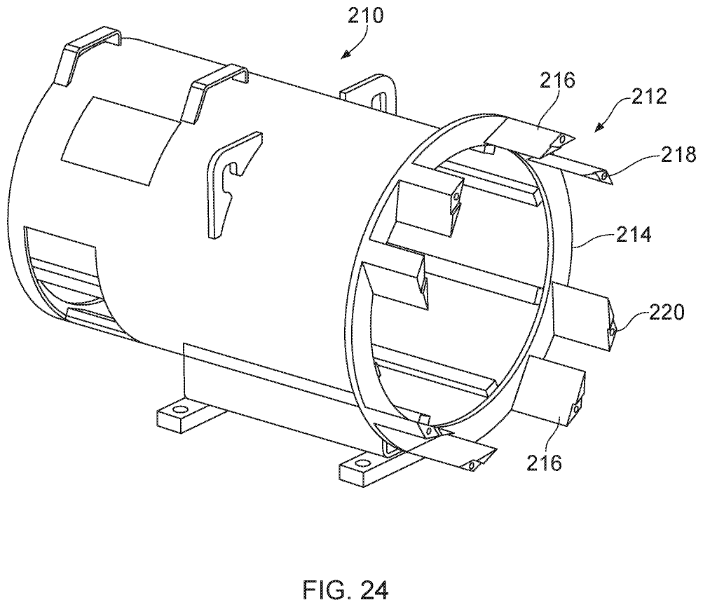

FIG. 24 shows a generator frame and a diffuser part of an adaptor in another embodiment; and

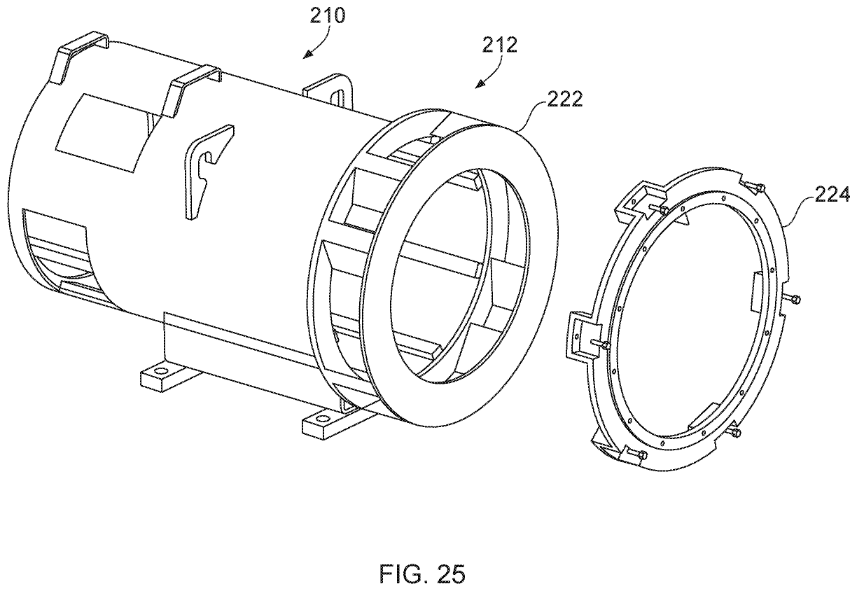

FIG. 25 shows the generator frame and diffuser part together with a spacer part.

FIG. 1 shows schematically a generating set comprising an engine 10 coupled to a generator (alternator) 12. The engine 10 is typically an internal combustion engine such as a petrol or diesel engine. The generator 12 may be any type of electrical generator, such as a synchronous generator with field coils or permanent magnets, and is typically housed in a generator frame. The engine 10 and generator 12 are both mounted on a bed frame 14. The crankshaft of the engine (not shown) is mechanically coupled to the rotor of the generator (not shown). In operation, mechanical energy produced by the engine 10 is transferred to the generator 12 in order to generate the electrical output.

In the arrangement of FIG. 1 the engine 10 comprises a flywheel located in a fly wheel housing 16. An adaptor 18 is used to connect the engine 10 to the generator 12. Typically, the adaptor is connected between the flywheel housing and the generator frame. The adaptor 18 helps to prevent relative movement between the engine and the generator. Openings 20 are provided in the adaptor, which provide exit paths for airflow through the generator. The openings 20 also allow an operator to connect the rotating parts once the generator has been brought into alignment with the engine.

FIG. 2 shows parts of a generator prior to assembly to an engine. Referring to FIG. 2, the generator 12 comprises a rotor and stator (not shown) inside a generator frame 22. The generator frame is connected to an adaptor 18, which is used to connect the generator to a flywheel housing. The generator also comprises a fan 26 and a coupling disc 28 mounted on a generator shaft 24. The fan 26 is located inside the adaptor 18. Openings 20 in the adaptor provide exit paths for airflow. During assembly, the generator 12 and adaptor 18 are brought into alignment with the engine. The openings 20 in the adaptor allow an operator to access to the coupling disc 28 as illustrated in FIG. 2. This allows the operator to bolt the coupling disc 28 to the engine flywheel. A socket wrench may be inserted through an opening 20 to tighten the bolts.

FIG. 3 shows a previously considered adaptor design. Referring to FIG. 3, the adaptor 30 comprises a front wall 32, a rear wall 34, and a plurality of vanes 36. The front wall 32 is arranged to connect the adaptor to a flywheel housing, while the rear wall 34 is arranged to connect the adaptor to the generator frame. The vanes 36 provide the physical connections between the front wall 32 and the rear wall 34, and thus function to ensure the physical rigidity of the adaptor. The rear wall 34 has a mating surface 38 with a plurality of bolt holes 40 for connecting the adaptor to the generator frame. The front wall 32 also has a mating surface and a plurality of bolt holes for connecting the adaptor to the flywheel housing. The adaptor 30 is arranged to house a fan 26, with the vanes 36 situated at spaced locations around the outside of the fan. The vanes 36 can act as diffusers, and can help reduce wake blockage, helping with the fan's ability to draw cooling air through the machine.

In the arrangement of FIG. 3, larger gaps or windows are left between some of the vanes 36 in a circumferential direction. The windows are used to provide access to the coupling disc, to allow the bolts to be inserted and tightened. Furthermore, the width of the vanes 36 in an axial direction is larger than the width of the fan. This leaves an axial gap between the fan 26 and the front wall 32, to allow insertion of a wrench between the fan and the coupling disc. These features allow access to the coupling disc. However, it has been found that they may reduce the diffusing properties of the adaptor, leading to a reduction in airflow rate. In particular, the number of vanes and their spacing may be less than optimal for good air diffusing capability. Furthermore, the axial gap between the fan and the front wall may create a void, leading to a loss in dynamic energy and a reduction in airflow rate. In addition, a relatively high strength grille may be needed to cover the windows for ingress protection, which may further imped airflow.

FIG. 4 shows an adaptor in an embodiment of the invention. The adaptor in this embodiment is designed to connect a generator housing to an engine flywheel housing. Referring to FIG. 4, the adaptor 50 is generally cylindrical, and is divided into two parts: a diffuser part 52 and a spacer part 54. The diffuser part 52 and spacer part 54 are adjacent to each other in an axial direction. The diffuser part 52 is designed to be connected to the generator housing and the spacer part 54 is designed to be connected to the engine flywheel housing. The division between the diffuser part 52 and the spacer part 54 is in a plane which is orthogonal to the axis of rotation of the generator.

The diffuser part 52 of the adaptor 50 is arranged to surround a fan 26 which is mounted on a generator shaft 24. The diffuser part 52 comprises a middle wall 56, a rear wall 58, and a plurality of vanes 60. The middle wall 56 and rear wall 58 are in the form of annular discs which are substantially concentric but spaced apart axially. The rear wall 58 comprises a curved annular surface 59 which helps to ensure smooth airflow from the generator into the fan 26. The rear wall 58 also comprises a mating surface 62 which interfaces with the generator housing and a plurality of bolt holes 64 for connecting the adaptor 50 to the generator housing. The middle wall 56 is connected to the spacer part 54 of the adaptor 50. The vanes 60 provide the physical connections between the middle wall 56 and the rear wall 58. Thus, the vanes 60 connect the middle and rear walls 56, 58 and space them apart axially. The vanes 60 are spaced circumferentially about the adaptor, around the outside of the fan 26. The vanes 60 are designed to maximise airflow whilst retaining the inherent structural benefits of a cylindrical adaptor.

In the arrangement of FIG. 4, the width of the vanes 60 in an axial direction is substantially equal to the width of the fan 26. Thus, the diffuser part 52 of the adaptor 50 is sized such that it accommodates the fan 26 but does not extend significantly beyond the fan in an axial direction. The middle wall 56 is substantially aligned with a back plate of the fan 26 in an axial direction.

The spacer part 54 of the adaptor 50 is arranged to space the diffuser part 52 axially from the flywheel housing, and to provide access to a coupling disc (not shown) for connecting the shaft 24 to the engine flywheel. The spacer part 54 comprises a front wall 66 and a plurality of cross members 68. The front wall 66 is in the form of an annular disc which is substantially concentric with the diffuser part 52 of the adaptor but spaced axially therefrom. The front wall 66 comprises a plurality of bolt holes 70 for connecting the adaptor 50 to the flywheel housing. The number and location of the bolt holes 70 may be governed by standard requirements, such as SAE (Society of Automotive Engineers) standards, or may be in any other appropriate configuration.

The cross members 68 are provided at spaced locations circumferentially about the spacer part 54 of the adaptor. The cross members 68 extend axially between the front wall 66 of the spacer part 54 and the middle wall 56 of the diffuser part 52. Thus, the cross members 68 connect the front wall 66 with the diffuser part 54 of the adaptor, and space them apart axially. In the arrangement shown, the cross members 68 have a T-shaped cross section when viewed axially. This can help to provide physical rigidity while minimising weight and amount of material.

In the arrangement of FIG. 4, the spacing between the cross members 68 in a circumferential direction is chosen to be sufficiently large to provide hand access to a coupling disc, while providing the necessary structural rigidity. Thus, the cross members 68 define access windows 72 which provide access to the coupling disc. Since the spacer part 54 of the adaptor does not surround the fan, the cross members do not need to provide air diffusion properties. Thus, it is possible for the cross members to be spaced further apart from each other and to be configured for structural rigidity rather than air diffusion. On the other hand, the spacing between the vanes 60 of the diffuser part 52 of the adaptor is chosen to optimise their air diffusion properties. Thus, the spacing between the vanes 60 in a circumferential direction is less than that between the cross members 68. This can allow the number of vanes 60, as well as their size, shape and angle to be chosen to optimize the function of air diffusion and provide structural rigidity, while still allowing access to the coupling disc.

FIG. 5 shows a cut-away view of part of the adaptor of FIG. 4. Referring to FIG. 5, it can be seen that the width of the vanes 60 in an axial direction is substantially the same as the width of the fan 26. Furthermore, the middle wall 56 is substantially aligned with a back plate 74 of the fan 26 in an axial direction, and located radially outwards thereof. This can allow airflow to be guided smoothly through the fan by the back plate 74 and the middle wall 56, through the gaps between the vanes 60 to the atmosphere. This arrangement therefore avoids the need for an axial gap between the fan 26 and the middle wall 56, which can help to improve the airflow.

From FIG. 5 it can also be seen that the width of the spacer part 54 in an axial direction is relatively small, compared to the overall size of the adaptor. This can allow the number and/or size of the cross members 68 to be reduced, thereby increasing the size of the access windows 72 in a circumferential direction. This can allow access windows 72 to be provided which are of a sufficient size to facilitate connection of the generator to the engine. In particular, the size of an access windows 72 in a circumferential direction is sufficient to allow a wrench to be inserted through the window and rotated through an angle sufficient to allow a bolt to be tightened. This can allow the access window to be used to tighten bolts which connect the coupling disc to the engine flywheel and/or the adaptor to the flywheel housing. The size of the window in the axial direction is sufficient to allow the wrench to be inserted into the window, but it need not allow for any significant movement of the wrench in an axial direction. Thus, the size of the window in an axial direction can be less than that in the circumferential direction.

The arrangement of FIGS. 4 and 5 can allow a sufficient number of vanes to ensure good diffusion properties to be provided, while at the same time providing windows for access to the coupling disc. In particular, the number of vanes 60 is larger than the number of cross members 68, which may help with the air diffusion properties of the diffuser part 52. Furthermore, an uneven distribution of the vanes, which may compromise the diffusion properties, can be avoided. The width of the vanes in an axial direction can be substantially the same as the width of fan. This can help to avoid a gap between the fan and the rear of the adaptor which would otherwise result in a loss of dynamic energy and thus reduce the fan's capability of drawing cooling air. Furthermore, a grille to cover the fan can be lighter than would otherwise be the case, further improving airflow.

FIGS. 6A to 6C show axial cross sections through the diffuser part 52 of the adaptor 50 of FIGS. 4 and 5, illustrating a number of possible configurations of the vanes 60. Referring to FIGS. 6A to 6C, the diffuser part 52 comprises middle wall 56 and a plurality of vanes 60 spaced circumferentially about the middle wall.)

In the configuration of FIG. 6A, the vanes 60 are in the form of flat plates. This may facilitate manufacture compared to other vane designs, although it may not provide the most optimal airflow.

In the configuration of FIG. 6B the vanes 60 are wedge-shaped, with a triangular cross-section. The wedge-shaped design presents a narrow edge to the airflow, while having a width at the outer circumference of the adaptor which ensures sufficient strength and rigidity. The wedge-shaped design may also allow the distance between adjacent vanes to increase with increasing distance outwards through the adaptor. This can provide a progressive reduction in air velocity with minimal turbulence and energy loss, and hence convert part of the dynamic pressure into additional static pressure rise through steady expansion of the air flow cross-section. Thus, the wedge-shaped design may help to improve airflow, by improving the air diffusion properties and reducing wake blockage, while ensuring sufficient structural strength.

In the configuration of FIG. 6C, the vanes 60 have an aerofoil (airfoil) shape. The aerofoil design may be advantageous in that it presents a narrow edge to the airflow, while also allowing the cross member to have a thinner, more aerodynamically efficient shape than some other designs, and thus may help to further improve the air diffusion properties. Thus, the aerofoil design may help to provide optimum airflow properties, although at the expense of some increase in complexity.

In the arrangements of FIGS. 6A to 6C, the vanes 60 are angled with respect to a radial direction. Generally, the angle is selected to be approximately the same as the angle at which airflow exits the fan. The width of the vanes and the number of vanes are selected to ensure sufficient physical strength, while minimising any obstruction to the air flow.

It will be appreciated that the vane designs of FIGS. 6A to 6C are given by way of example only, and other configurations of vanes could be used instead or as well. For example, the vanes may be in any of the forms disclosed in WO 2019/243829 A1, the subject matter of which is incorporated herein by reference. In general, the number, size, shape and angle of the vanes are chosen to provide the desired air diffusion properties, while ensuring sufficient structural support and ease of manufacture.

In the arrangement of FIGS. 4 to 6, the spacer part 54 of the adaptor may be attached to the diffuser part 52 in any appropriate manner, for example, by bolting or by welding. Alternatively, the adaptor including the diffuser part 52 and the spacer part 54 may be manufactured (for example, cast, machined and/or fabricated) as a single piece. In another possible arrangement, the diffuser part could be manufactured (for example, fabricated) as part of the frame. This would make the frame and diffuser a single part. It would also be possible for the whole adaptor (comprising the diffuser part and spacer part) to be manufactured as part of the frame. In any arrangement, the adaptor may be manufactured, for example, from a metal such as such as a ferrous metal or an aluminium-based alloy or any other appropriate material.

Where the spacer part 54 of the adaptor is manufactured separately from the diffuser part 52, it may be possible for different types of spacer part 54 to share the same diffuser part 52. For example, a plurality of differently sized spacer parts 54 could be provided, to allow the adaptor 50 to connect to a range of different prime movers while using the same diffuser part 52. The differently sized spacer parts 54 may for example allow connections to different SAE sizes. Alternatively, or in addition, it may be possible for single and double bearing machines to share the same diffuser part.

In the arrangement of FIGS. 4 to 6, the middle wall 56 is provided as part of the diffuser part of the adaptor. However, in alternative arrangements, all or part of the middle wall could be provided as part of the spacer part of the adaptor.

FIG. 7 shows a diffuser part of the adaptor in one embodiment. Referring to FIG. 7, the diffuser part 52 comprises middle wall 56, rear wall 58, and a plurality of vanes 60, which may be in the form discussed above with reference to FIGS. 4 to 6.

FIG. 8A shows a spacer part for connection to the diffuser part of FIG. 7. Referring to FIG. 8A, the spacer part 54 comprises a front wall 66 and a plurality of cross members 68, which may be substantially in the form discussed above. The front wall 66 comprises a plurality of bolt holes 70 for connecting the adaptor 50 to the flywheel housing. The number and location of the bolt holes 70 may be governed by standard requirements, such as SAE standards. A plurality of different versions of the spacer part 54 may be provided, in order to connect the adaptor to a plurality of different flywheel housings, while using the same diffuser part 52 such as that shown in FIG. 7. This may allow the cost of manufacture to be reduced by allowing different adaptors to share the same diffuser part.

FIG. 8B shows a bearing support part for connection to the diffuser part of FIG. 7. The bearing support part in FIG. 8B is designed to support a bearing in a two-bearing machine. Referring to FIG. 8B, the bearing support part 76 comprises a front wall 78 and a bearing support 80. The bearing support 80 is used to support a bearing housing. The diffuser part 52 and the bearing support part 76 in combination function as a bracket for use with a two-bearing generator, in which one end of the generator shaft is supported by bearings held by the bracket rather than using engine bearings. This can allow single and double bearing machines to share the same diffuser part, reducing the cost of manufacture.

In the arrangement of FIG. 8B, the front wall 78 in the bearing support part 76 comprises a plurality of bolt holes 82. The bolt holes 82 can be used to connect a separate adaptor to the bearing support part. The adaptor can be used to connect the bracket to the prime mover. If desired, the adaptor and the bearing support part 76 and/or the diffuser part may be provided as a single component. Alternatively, the generator and the engine could be mounted on a bed frame without the use of an adaptor to connect the bearing support part to the engine.

The arrangements described above with reference to FIGS. 4 to 8 may provide some or all of the following benefits:
Thermal benefits for both stator and rotor by improving airflow through the machine.
Flexible replacement of the spacer part to match up with different SAE connections instead of replacing the whole adaptor.
May be able to avoid interference with the engine by designing a smaller spacer part than would otherwise be possible.
Single and double bearing machines can share the same diffuser part.
Stronger support may make it possible to use a grille with higher porosity and weaker structure.
It may be possible to use a smaller fan to achieve the same thermal level.
Reduced turbulence of air passing through the diffuser may reduce noise.
There may also be an improvement in machine efficiency (less windage loss).

FIG. 9 shows an adaptor in another embodiment of the invention. Referring to FIG. 9, the adaptor 90 is generally cylindrical, and is divided into two parts: a diffuser part 92 and a spacer part 94. The diffuser part 92 is designed to be connected to the generator housing and the spacer part 94 is designed to be connected to the engine flywheel housing. The diffuser part 92 is arranged to surround a fan 26 which is mounted on a generator shaft 24. The diffuser part 92 comprises a middle wall 96, a rear wall 98, and a plurality of vanes 100, in a similar way to the diffuser part described above. The spacer part 94 comprises a front wall 102 and a plurality of cross members 104. The cross members 104 are provided at spaced locations circumferentially about the spacer part 94 of the adaptor. The cross members 104 define access windows 106 which provide access to a coupling disc.

In the adaptor 90 of FIG. 9, the diffuser part 92 and the spacer part 94 are formed integrally. This may be achieved, for example, by casting the adaptor 90 as a single piece. The cross members 104 extend axially between the front wall 102 and the middle wall 96. In this embodiment, the cross members 104 have a U-shaped cross section when viewed axially.

FIG. 10 shows a cutaway view through part of a generator with the adaptor of FIG. 9 in place. Referring to FIG. 10, the generator comprises a rotor and stator (not shown) inside a generator frame 22. The generator also comprises a generator shaft 24. A fan 26 is mounted on the shaft 24 via a fan hub 108. A coupling disc 28 is mounted on the shaft 24 via a coupling disc hub 110. The coupling disc 28 is connected to the hub 110 using bolts 112. The adaptor 90 is connected to the generator frame 22. The fan 26 is located inside the diffuser part 92 of the adaptor 90.

In FIG. 10 it can be seen that the width of the vanes 100 in an axial direction is substantially the same as the width of the fan 26. Furthermore, the middle wall 96 is substantially aligned with a back plate 74 of the fan 26 in an axial direction, and the middle wall 96 is located radially outwards of the back plate 74. This can allow airflow to be guided smoothly through the diffuser part 92 of the adaptor by the back plate 74 and the middle wall 96, through the gaps between the vanes 100 to the atmosphere. Access to the coupling disc 28 is provided through the access windows 106 in the spacer part 94 of the adaptor 90.

FIGS. 11A and 11B show an adaptor in another embodiment of the invention. Referring to FIG. 11A, the adaptor 120 is generally cylindrical, and is divided into two parts: a diffuser part 122 and a spacer part 124. The diffuser part 122 comprises a middle wall, a rear wall and a plurality of vanes, in a similar way to the diffuser part of FIGS. 9 and 10. The spacer part 124 comprises a front wall and a plurality of U-shaped cross members, in a similar way to the spacer part of FIGS. 9 and 10. However, in the embodiment of FIG. 11, the diffuser part 122 and the spacer part 124 are manufactured as separate components. The spacer part 124 is connected to the diffuser part 122 using a plurality of bolts 118. The bolts 118 pass through holes 126 in the cross members. The diffuser part 122 comprises a plurality of bolt holes 128 for receiving the bolts 118. FIG. 11B shows the adaptor with the spacer part 124 connected to the diffuser part 122.

The arrangement of FIGS. 11A and 11B can allow the spacer part 124 to be removed and replaced, for example, if the generator is be connected to an engine with a different SAE interface. Alternatively or in addition, a bearing support part may be connected to the diffuser part, in a similar way to that described above. Although FIGS. 11A and 11B show a spacer part with U-shaped cross members, it will be appreciated that T-shaped cross members, or any other suitably shaped cross members, could be used instead or as well.

FIGS. 12A and 12B illustrate how the diffuser part of FIGS. 11A and 11B can be used together with a bearing support part. Referring to FIG. 12A, a bearing support part 130 is provided for connection to the diffuser part 122. The bearing support part 130 is designed to support a bearing housing. The diffuser part 122 and the bearing support part 130 in combination function as a bracket for use with a two-bearing generator. This can allow single and double bearing machines to share the same diffuser part, reducing the cost of manufacture.

The arrangements described above can allow the adaptor to act as a diffuser for airflow from the fan and at the same time provide access to the coupling disc. Since the spacer part is relatively narrow in an axial direction, it does not need to be as strong and therefore a larger gap can be left between the cross members. However, in some circumstances, the relatively small axial narrow width of the spacer part may restrict access.

In further embodiments of the invention, a section of the adaptor is removable to provide improved access.

FIG. 13 shows an adaptor in another embodiment of the invention. Referring to FIG. 13, the adaptor comprises two parts: a diffuser part 132 and a spacer part 134. In the arrangement shown, the diffuser part 132 and the spacer part 134 are a single piece. However, it would also be possible for the diffuser part and the spacer part to be separate components which are connected together in any of the ways described above.

In FIG. 13, the diffuser part 132 comprises a middle wall 136, a rear wall 138 and a plurality of vanes 140, in a similar way to the diffuser parts described above. The spacer part 134 comprises a front wall 142 and a plurality of T-shaped cross members 144, in a similar way to the spacer part of FIGS. 4 to 8. However, in this embodiment, the front wall 142 comprises a plurality of removable sections 146. The removable sections 146 are attached to the front wall 142 using a plurality of screws 148.

In use, the removable sections 146 can be removed from the adaptor by undoing the screws 148. This can allow improved access to the coupling disc while the generator is being attached to the engine. The removable sections 146 can then be reattached to the front wall 142 using the screws 148.

The removable sections 146 may be, for example moulded metal, or sheet metal components, or made using any other appropriate material and/or manufacturing method. Self-locking or “snap” fit features could also be used as well as (or instead of) the screws 148. Although six removable sections are shown in FIG. 13, any appropriate number of removable sections could be provided of any appropriate size and at any appropriate location.

FIG. 14 shows part of the adaptor of FIG. 13 with a removable section removed. Referring to FIG. 14, it can be seen that the front wall 142 of the adaptor comprises a window 150. The window 150 extends circumferentially in an area between two cross members 144. The window 150 also extends radially inwards from an outer edge of the front wall 142. However, the window 150 only extends part way through the front wall 142 in a radial direction, leaving an inner ring 152 of the front wall. This helps to ensure that structural rigidity is maintained. A screw hole 154 is provided on either side of the window 150 circumferentially to receive the screws 148. The window 150 aids hand access to the coupling disc during assembly of the generator to the engine.

FIG. 15 shows one of the removable sections in more detail. Referring to FIG. 15, the removable section 146 is generally arc-shaped, and has a hole 156 at each end for receiving the screws 148. In this embodiment, the removable section 146 has a step 158 to aid location when it is being assembled to the adaptor. The step 158 is designed to engage with the sides of the front wall 142 which form the window 150. This feature may alternatively or in addition be achieved using location pins, or any other similar feature.

FIG. 16 shows an adaptor in another embodiment of the invention. Referring to FIG. 16, the adaptor is divided into two parts: a diffuser part 162 and a spacer part 164, in a similar way to the adaptors described above. The diffuser part 162 comprises a middle wall 166, a rear wall 168 and a plurality of vanes 170. The spacer part 164 comprises a front wall 172 and a plurality of T-shaped cross members 174.

In this embodiment, the adaptor comprises a plurality of removable vane sections 176. Each of the removable vane sections 176 replaces part of the middle wall 166 and part of the vanes 170. The removable vane sections 176 are attached to the middle wall 166 using a plurality of screws 178. The removable vane sections 176 may be, for example, moulded plastic, moulded metal, sheet metal components, or made using any other appropriate material and/or manufacturing method.

In use, the removable vane sections 176 can be removed from the adaptor by undoing the screws 178. This can allow improved access to the coupling disc while the generator is being attached to the engine. The removable vane sections 176 can then be reattached to the middle wall 166 using the screws 178. If desired, self-locking or “snap” fit features could also be used as well as (or instead of) the screws 178.

FIG. 17 shows part of the adaptor of FIG. 16 with a removable vane section removed. Referring to FIG. 17, it can be seen that the adaptor comprises a window 180 in the place of part of the middle wall 166 and part of the vanes 170. The window 180 extends circumferentially for a distance approximately equivalent to the distance between two adjacent vanes in a circumferential direction. Two screw holes 182 are provided in the middle wall 166, one on each side of the window 180 circumferentially, to receive the screws 178. A recess 184 is provided on the inner surface of the rear wall 168 to aid location of the removable vane section 176. The window 180 aids hand access to the coupling disc during assembly of the generator to the engine.

FIGS. 18 and 19 show a front view and rear view of one of the removable vane sections in more detail. Referring to FIGS. 18 and 19, the removable vane section 176 comprises a wall member 186 which is designed to replace part of the middle wall 166 and two vane members 188, 190 which are designed to replace parts of two of the vanes 170. The wall member 186 is generally arc-shaped, and includes a tab at each end with a hole 192 for receiving the screws 178. The first vane member 188 replaces the majority of one of the vanes, with the exception of one end where the vane lies radially inwards of an adjacent vane on one side. The second vane member 190 replaces a part of an adjacent vane on the other side which lies radially inwards of the first vane member 188. Since the vanes 170 partially overlap each other in a circumferential direction, this arrangement allows a segment of the vanes 170 and the middle wall 166 to be removed, to improve hand access during assembly.

FIG. 20 shows an adaptor in another embodiment of the invention. The adaptor of FIG. 20 is similar to that of FIG. 16. However, in this embodiment, each removable vane section includes one complete vane. Referring to FIG. 20, the adaptor comprises a middle wall 166, a rear wall 168, a plurality of vanes 170, a front wall 172, a plurality of T-shaped cross members 174, and a plurality of removable vane sections 194. Each of the removable vane sections 194 replaces part of the middle wall 166 and one of the vanes 170. The removable vane sections 196 are attached to the middle wall 166 using a plurality of screws 178.

FIG. 21 shows part of the adaptor of FIG. 20 with a removable vane section removed. Referring to FIG. 21, it can be seen that the adaptor comprises a window 196 in the place of part of the middle wall 166 and one of the vanes 170. The window 196 extends circumferentially through part of the middle wall 166 in the place where a vane would be. The window 196 also extends radially inwards from an outer edge of the middle wall 166. However, the window 196 only extends part way through the middle wall 166 in a radial direction, leaving an inner ring of the middle wall. This helps to ensure that structural rigidity is maintained. Two screw holes 182 are provided in the middle wall 166, one on each side of the window 196 circumferentially, to receive the screws 178. A recess 184 is provided on the inner surface of the rear wall 168 to aid location of the removable vane section 194. The window 196 aids hand access to the coupling disc during assembly of the generator to the engine.

FIG. 22 shows one of the removable vane sections of FIG. 20 in more detail. Referring to FIG. 22, the removable vane section 194 comprises a wall member 198 which is designed to replace part of the middle wall 166 and a vane member 200 which is designed to replace one of the vanes 170. The wall member 198 includes a tab at each end with a hole 202 for receiving the screws 178.

FIG. 23 shows part of an adaptor in a further embodiment of the invention. In this embodiment, the adaptor comprises a diffuser part and a spacer part which may be substantially in any of the forms described above. Referring to FIG. 23, the diffuser part of the adaptor comprises a rear wall 168 and a plurality of vanes 170. A plurality of covers 204, 206 are provided which extend circumferentially around the outside of the adaptor. Each cover has a plurality of holes which allow air to exit the adaptor while providing ingress protection. The removable covers may be press fitted into the adaptor and/or attached in any other way, such using bolts, snap-on or “click together” features etc.

In the arrangement of FIG. 23, some of the vanes are “missing” from the diffuser part of the adaptor. Thus, gaps are provided between some of the vanes in a circumferential direction, where a vane would otherwise be. The “missing” vanes can allow access to the inside of the adaptor to be improved, which can facilitate assembly and/or servicing of the generating set. Two different types of cover are used. A first type of cover 204 is provided radially outwards of one or more vanes 170. The second type of cover 206 includes a vane 208 which replaces a “missing” vane on the adaptor.

During assembly, the removable covers 204, 206 can be removed to allow access to the coupling disc. The “missing” vanes can allow improved access to inside the adaptor, which can facilitate assembly and/or servicing of the generating set. By including the “missing” vane on the removeable cover 206, the aerodynamic performance of the adaptor can be maintained.

It will be appreciated that, if desired, other parts of the adaptor could be removable to improve hand access instead of or as well as those described above. Furthermore, different types of removable part may be used together on the same adaptor.

FIG. 24 shows a generator frame and a diffuser part of an adaptor in another embodiment. In this embodiment, the diffuser part of the adaptor and the generator frame are provided as a single component.

Referring to FIG. 24, the generator frame 210 is in the form of a cylindrical housing which is arranged to house the generator (not shown). The diffuser part 212 of the adaptor is integral with the generator frame 210. The diffuser part of the adaptor comprises a rear wall 214 and a plurality of vanes 216. The rear wall is in the form of an annular disc at the drive end of the generator frame 210. The vanes 216 are wedge-shaped vanes which extend axially outwards from the rear wall 214. In this embodiment, the diffuser part of the adaptor does not include a middle wall, which is instead provided on the spacer part (not shown). The axially outward (front) face of each of the vanes 216 is designed to interface with the middle wall on the spacer part. The vanes 216 have locating features 218 which are used to locate the spacer part. Bolt holes 220 are provided in the vanes 216, in order to connect the spacer part to the diffuser part. The combined generator frame and diffuser part of the adaptor may be manufactured using any appropriate technique such as fabrication (e.g. steel fabrication).

As in previous embodiments, in the arrangement of FIG. 24 the diffuser part of the adaptor is sized such that it accommodates the fan but does not extend significantly beyond the fan in an axial direction. The spacer part of the adaptor is arranged to space the diffuser part axially from the flywheel housing, and to provide access to a coupling disc for connecting the shaft to the engine flywheel.

In the arrangement shown in FIG. 24, the locating features 218 on the vanes 216 are machined spigots. However, other types of locating feature, such as dowel pins, could be used instead or as well to align the spacer part to the vanes.

FIG. 25 shows the generator frame and diffuser part of the adaptor together with a spacer part. Referring to FIG. 25, in this embodiment a middle wall 222 is attached to the vanes in the diffuser part 212. The spacer part 224 is then attached to the middle wall 222. Different sized spacer parts may be used, to allow the adaptor to connect to a range of different prime movers.

If desired, a combined diffuser part and generator frame assembly could be provided using any of the adaptor designs described herein.

Embodiments of the invention have been described by way of example only, and modifications in detail will be apparent to the skilled person. For example, the cross members, vanes and other components of the adaptor may have different dimensions, orientations and numbers than those shown. In any of the embodiments, all or part of the middle wall could be provided as part of the spacer part of the adaptor. Features of one embodiment may be used with any of the other embodiments. Other variations in detail will be apparent to the skilled person within the scope of the claims.

1-25. (canceled)

26. An adaptor arranged to connect a rotating electrical machine to a prime mover, the adaptor comprising:
a first part arranged to surround a fan; and
a second part arranged to provide access to a rotating component for connecting the rotating electrical machine to the prime mover.

27. The adaptor according to claim 26, wherein the first part is arranged to connect to the rotating electrical machine, and the second part is arranged to connect to the prime mover.

28. The adaptor according to claim 26, wherein the first part and the second part are adjacent to each other in an axial direction.

29. The adaptor according to claim 26, wherein the first part and the second part in combination are arranged to provide a physical connection between the machine and the prime mover.

30. The adaptor according to claim 26, wherein the second part is arranged to space the first part axially from the prime mover.

31. The adaptor according to claim 26, wherein the second part comprises a front member and a plurality of cross members which connect the front member to the first part.

32. The adaptor according to claim 31, wherein an access window is defined between two adjacent cross members in a circumferential direction.

33. The adaptor according to claim 26, wherein the first part comprises a plurality of exit paths for airflow from the fan.

34. The adaptor according to claim 26, wherein the first part is arranged to provide a steady expansion of airflow cross-section.

35. The adaptor according to claim 26, wherein the adaptor comprises a middle member arranged to separate the first part and the second part, and the first part comprises a rear member and a plurality of vanes which connect the middle member to the rear member.

36. The adaptor according to claim 35, wherein the middle member is ring-shaped.

37. The adaptor according to claim 35, wherein the vanes are flat, wedge-shaped or aerofoil-shaped, and are at an angle with respect to a radial direction.

38. The adaptor according to claim 35, wherein the second part comprises a front member and a plurality of cross members which connect the front member to the middle member, and the number of vanes is greater than the number of cross members.

39. The adaptor according to claim 35, wherein the vanes have a width in an axial direction which is substantially the same as a width of the fan.

40. The adaptor according to claim 35, wherein the fan comprises a backplate, and the middle member is substantially aligned with the backplate in an axial direction.

41. The adaptor according to claim 26, wherein the second part is removably connected to the first part.

42. The adaptor according to claim 26, the adaptor comprising at least one section which is removable to improve access to the rotating component for connecting the rotating electrical machine to the prime mover.

43. The adaptor according to claim 26, further comprising at least one removable cover, wherein the at least one removable cover comprises a vane.

44. A rotating electrical machine comprising a rotor, a stator, a stator frame, a fan and an adaptor, the adaptor comprising:
a first part connected to the stator frame; and
a second part arranged to be connected to a prime mover,
wherein the first part is arranged to surround the fan, and
the second part is arranged to provide access to a rotating component for connecting the rotating electrical machine to the prime mover.

45. A method of connecting a rotating electrical machine to a prime mover using an adaptor, the adaptor comprising a first part and a second part, the method comprising:
connecting the adaptor to the rotating electrical machine such that the first part surrounds a fan; and
accessing a rotating component through the second part to connect the rotating electrical machine to the prime mover.
